(19) United States
(12) Patent Application Publication
(10) Pub. No.: US 2017/0064114 A1
(43) Pub. Date: Mar. 2, 2017

(54) IMAGE FORMING APPARATUS, NON-TRANSITORY COMPUTER READABLE MEDIUM, AND IMAGE FORMING METHOD

(71) Applicant: FUJI XEROX CO., LTD., Tokyo (JP)

(72) Inventors: Daisuke FUJII, Kanagawa (JP); Hidekazu KANKE, Kanagawa (JP); Kaname TOMATSURI, Kanagawa (JP); Kazuya MORINO, Kanagawa (JP); Nobuyuki KOBAYASHI, Kanagawa (JP)

(73) Assignee: FUJI XEROX CO., LTD., Tokyo (JP)

(21) Appl. No.: 15/009,002

(22) Filed: Jan. 28, 2016

(30) Foreign Application Priority Data
Aug. 24, 2015 (JP) 2015-164793

(51) Int. Cl. H04N 1/00; H04N 1/60; H04N 1/387

(52) U.S. Cl. CPC H04N 1/00779; H04N 1/3872; H04N 1/6097; H04N 1/00724; H04N 2201/0082

(57) ABSTRACT

An image forming apparatus includes a first controller configured to store associated information for multiple accommodating units accommodating paper, the associated information associating identification information with adjustment information, the identification information identifying each of the accommodating units, the adjustment information being used to adjust at least one of a position of an image formed on the paper, a color of the image, and a tone of the image, and second controller configured to form an adjusted image on target paper, the adjusted image being adjusted by using adjustment information stored in association with identification information of at least one of the accommodating units accommodating the target paper.

### CROSS-REFERENCE TO RELATED APPLICATIONS

This application is based on and claims priority under 35 USC 119 from Japanese Patent Application No. 2015-164793 filed Aug. 24, 2015.

### BACKGROUND

### Technical Field

The present invention relates to an image forming apparatus, a non-transitory computer readable medium, and an image forming method.

### SUMMARY

According to an aspect of the invention, there is provided an image forming apparatus including a first controller configured to store associated information for multiple accommodating units accommodating paper, the associated information associating identification information with adjustment information, the identification information identifying each of the accommodating units, the adjustment information being used to adjust at least one of a position of an image formed on the paper, a color of the image, and a tone of the image, and a second controller configured to form an adjusted image on target paper, the adjusted image being adjusted by using adjustment information stored in association with identification information of at least one of the accommodating units accommodating the target paper.

### BRIEF DESCRIPTION OF THE DRAWINGS

Exemplary embodiments of the present invention will be described in detail based on the following figures, wherein:

FIG. 1 is a diagram illustrating the configuration of an image forming apparatus according to a first exemplary embodiment;

FIG. 2 is a diagram illustrating the configuration of an image forming unit according to the first exemplary embodiment;

FIG. 3 is a diagram illustrating the configuration of a toner image forming unit according to the first exemplary embodiment;

FIG. 4 is a block diagram illustrating a controller according to the first exemplary embodiment;

FIG. 5 is a schematic representation of an image adjustment table according to the first exemplary embodiment;

FIG. 6 is a schematic representation of an attribute information table according to the first exemplary embodiment;

FIG. 7 is a schematic representation of a list of attributes in attribute information according to the first exemplary embodiment;

FIG. 8 is a schematic representation of a calibration table according to the first exemplary embodiment;

FIG. 9 is a schematic representation of a print job according to the first exemplary embodiment;

FIG. 10 is a block diagram illustrating a computer capable of implementing a controller according to the first exemplary embodiment;

FIG. 11 is a flowchart of a print procedure according to the first exemplary embodiment;

FIG. 12 is a schematic representation of a process according to the first exemplary embodiment, illustrating how calibration information is registered into an image adjustment table;

FIG. 13 is a flowchart of a procedure according to a second exemplary embodiment for updating stock information;

FIG. 14 is a schematic representation of a process according to the second exemplary embodiment, illustrating how the same calibration information is used also for stock information with similar attribute information;

FIG. 15 is a flowchart of a print procedure according to a third exemplary embodiment; and

FIG. 16 is a flowchart of a procedure according to the third exemplary embodiment for determining the necessity of updating.

### DETAILED DESCRIPTION

Hereinafter, an image forming apparatus according to exemplary embodiments of the present invention will be described in detail with reference to the drawings. An arrow H in the drawings indicates the height direction of the apparatus, and an arrow W indicates the width direction of the apparatus. In the following description, a direction orthogonal to each of the height direction of the apparatus and the width direction of the apparatus will be defined as the depth direction of the apparatus.

### First Exemplary Embodiment

### General Arrangement of Image Forming Apparatus

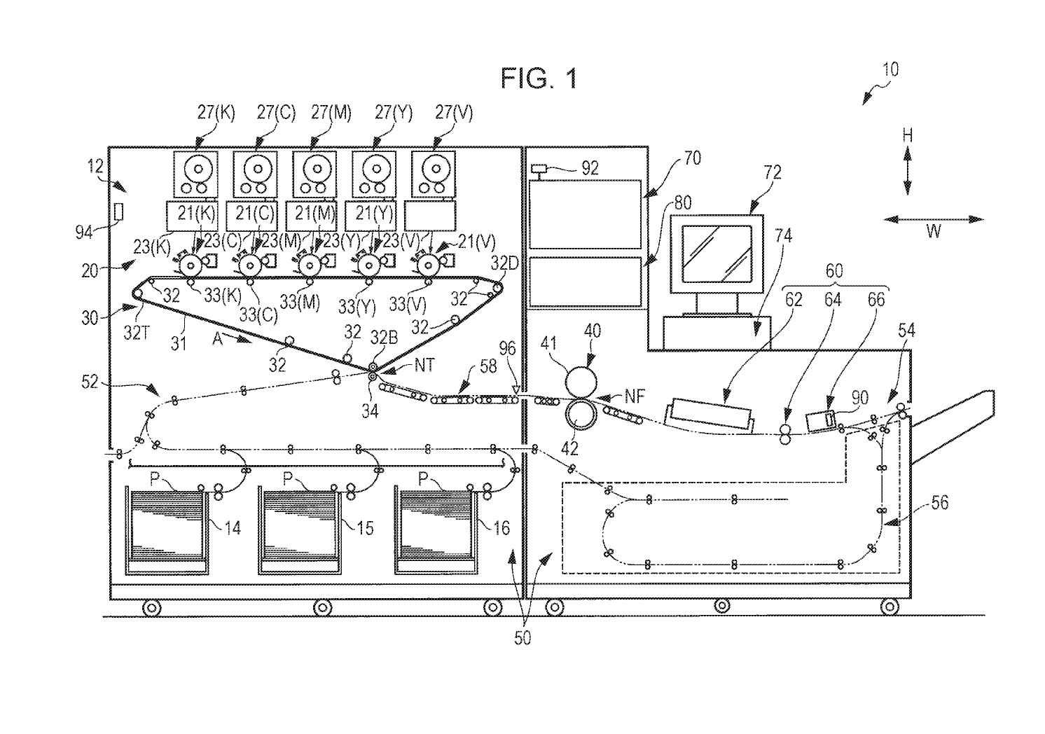

FIG. 1 is a diagram of the configuration of an image forming apparatus 10 according to an exemplary embodiment of the present invention, illustrating the general arrangement of the image forming apparatus 10 as viewed from the front.

As illustrated in FIG. 1, the image forming apparatus 10 has an image forming unit 12, a medium transport unit 50, and a postprocessing unit 60. The image forming unit 12 forms an image on a sheet member P, which is an example of a recording medium, by the electrophotographic system. The medium transport unit 50 transports the sheet member P. The postprocessing unit 60 performs postprocessing and other processing on the sheet member P on which an image has been formed. The image forming apparatus 10 also includes a controller 70, and a power supply unit 80. The controller 70 controls each of the above-mentioned units and the power supply unit 80. The power supply unit 80 supplies electric power to each of the above-mentioned units including the controller 70. The controller 70 is connected with a display 72, and a console 74 (details of which will be described later).

The sheet member P is accommodated in each of a first accommodating unit 14, a second accommodating unit 15, and a third accommodating unit 16. The sheet member has paper properties such as size, color, mass, grain, material type, and coat indicative of the surface condition. In the first exemplary embodiment, the first to third accommodating units 14 to 16 individually accommodate sheet members P with at least partially matching paper properties, or sheet members P with different paper properties. Although the sheet members P are accommodated at three locations, namely, the first to third accommodating units 14 to 16 in the first exemplary embodiment, the sheet members P may be accommodated at two locations or at four or more locations.

The image forming unit 12 is provided with an environment detection sensor 94 to detect at least one of an environmental temperature and an environmental humidity, which is an example of the environment of the image forming apparatus 10. The image forming unit 12 is provided with a paper sensor 96 that counts the number of sheet members P on which an image has been formed. Further, an image inspection unit 66 of the postprocessing unit 60 is provided with an image adjustment sensor 90. The image adjustment sensor 90 detects data for obtaining adjustment information related to image adjustments made in forming an image. Furthermore, the controller 70 is connected with a timer 92 that counts time such as date or counts elapsed time.

Configuration of Image Forming Unit

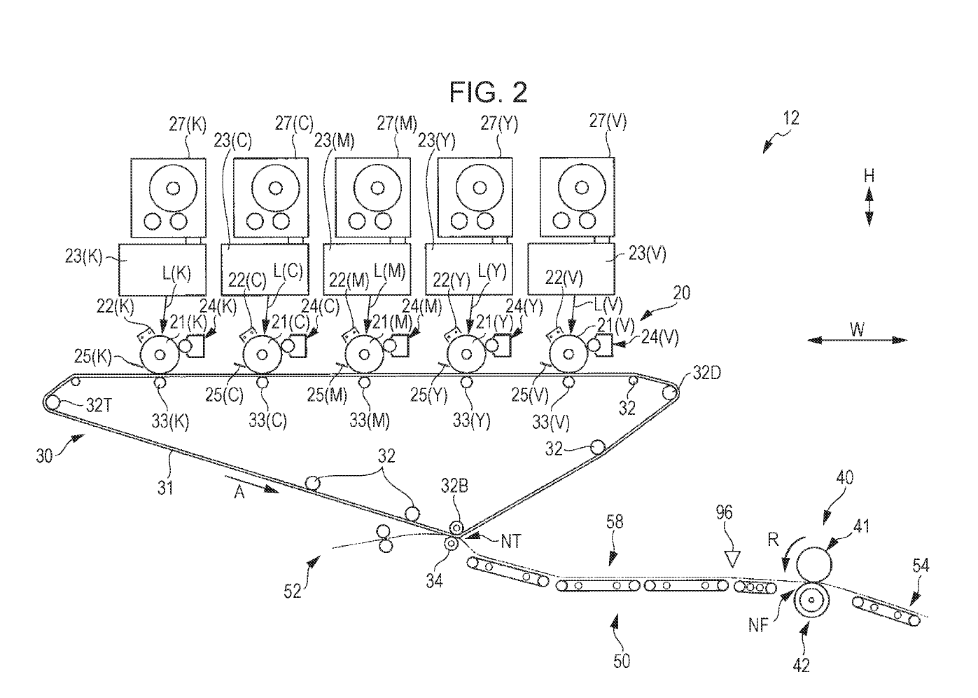

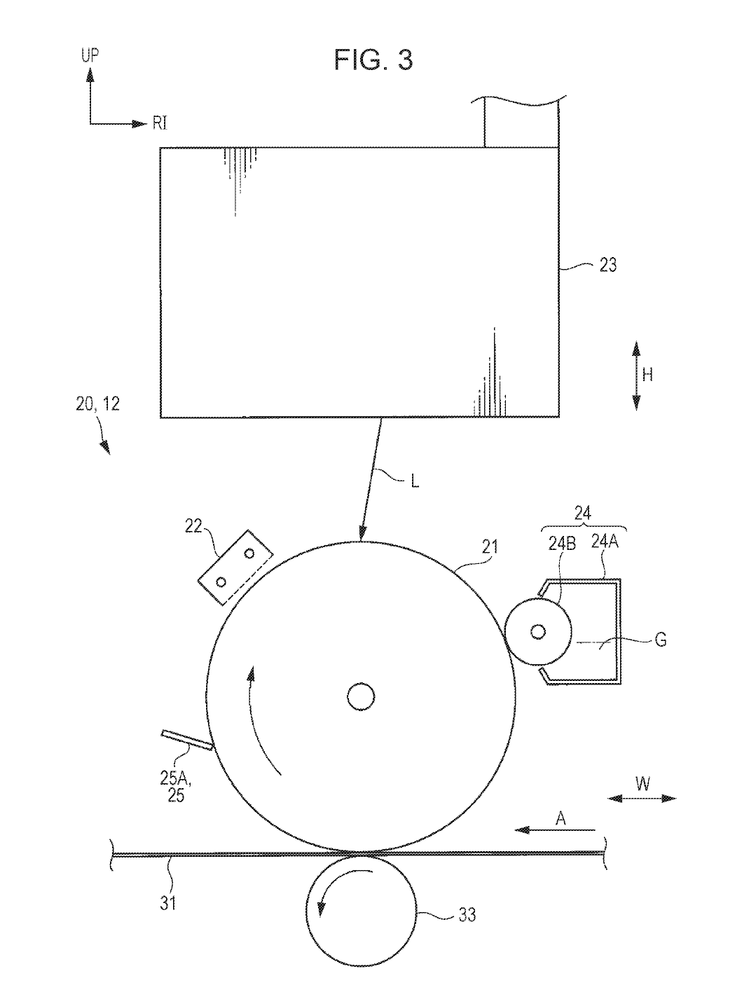

FIG. 2 is a diagram of the configuration of the image forming unit 12 in the image forming apparatus 10 according to the first exemplary embodiment, schematically illustrating the image forming unit 12 as viewed from the front. FIG. 3 is a diagram of the configuration of one of toner image forming units 20 included in the image forming unit 12, schematically illustrating the toner image forming unit 20 as viewed from the front. The image forming unit 12 forms a multi-color image using the following five colors of toner (developer): special color (V), yellow (Y), magenta (M), cyan (C), and black (K).

As illustrated in FIG. 2, the image forming unit 12 includes photoconductor drums 21, which are an example of a latent image carrier, charging units 22, exposure devices 23, developing devices 24, and cleaning devices 25. The image forming unit 12 includes the toner image forming units 20 (see also FIG. 3) that each form a toner image, a transfer device 30 that transfers an image formed by each of the toner image forming units 20 to the sheet member P, and a fixing device 40 that fixes the toner image transferred to the sheet member P onto the sheet member P.

Each of the toner image forming units 20 forms a toner image in a different color. In the first exemplary embodiment, the toner image forming units 20 for individually forming toner images in a total of five colors including special color (V), yellow (Y), magenta (M), cyan (C), and black (K) are provided. The English alphabetic characters V, Y, M, C, and K in parentheses in FIGS. 1 and 2 respectively indicate correspondence to the above-mentioned colors, namely, special color, yellow, magenta, cyan, and black. In the following description, although symbols with the alphabetic character V, Y, M, C, or K added after the numerals will be used to distinguish between special color, yellow, magenta, cyan, and black, when it is unnecessary to distinguish between these colors, the alphabetic character V, Y, M, C, or K will not be added after the numerals.

Each of the developing devices 24 is connected with a corresponding one of toner cartridges 27 by a supply path (not illustrated). The toner cartridge 27, which is an example of a consumable item, is detachably attached to the image forming apparatus 10. Developer G including toner accommodated in the toner cartridge 27 is supplied to the developing device 24. As illustrated in FIGS. 1 and 2, the toner cartridges 27 for individual colors are disposed above the corresponding photoconductor drums 21 and the corresponding exposure devices 23 such that the toner cartridges 27 are arranged side by side in the width direction of the apparatus as viewed from the front. This arrangement allows the toner cartridges 27 to be replaced individually.

At a transfer nip NT, the transfer device 30 transfers separate toner images in five colors that have been transferred to a transfer belt 31, which is an example of a toner image carrier, in a superimposed manner through first transfer, from the transfer belt 31 to the sheet member P as a composite toner image with five colors.

In the first exemplary embodiment, the special color (V) used may be either a metallic color for adding metallic luster to the image, or a user-specific corporate color used frequently compared with other colors.

Photoconductor Drums

As illustrated in FIGS. 2 and 3, each of the photoconductor drums 21 has a cylindrical shape, and is driven by a driving unit (not illustrated) to rotate around its own axis. The outer peripheral surface of the photoconductor drum 21 is provided with, for example, a photosensitive layer that is charged to negative polarity. The outer peripheral surface of the photoconductor drum 21 may be provided with an overcoat layer. The photoconductor drums 21 for individual colors are arranged side by side in a linear configuration in the width direction of the apparatus as viewed from the front.

Charging Units

Each of the charging units 22 charges the outer peripheral surface (photosensitive layer) of the corresponding photoconductor drum 21 to negative polarity. In the first exemplary embodiment, the charging unit 22 is a Scorotron charging unit that employs the corona discharge system (contactless charging system).

Exposure Devices

Each of the exposure devices 23 forms an electrostatic latent image on the outer peripheral surface of the corresponding photoconductor drum 21. Specifically, in accordance with image data obtained by performing image adjustments such as image processing on an image of a print job J input to the controller 70, the exposure device 23 irradiates the outer peripheral surface of the photoconductor drum 21 charged by the charging unit 22 with modulated exposure light L (see FIG. 3). The irradiation of the photoconductor drum 21 with the exposure light L by the exposure device 23 creates an electrostatic latent image on the outer peripheral surface of the photoconductor drum 21. In the first exemplary embodiment, the exposure device 23 performs exposure on the surface of the photoconductor drum 21 by scanning a light beam applied from a light source across the surface with a light scanning unit (optical system) including a polygon mirror or an F-theta lens.

Developing Devices

Each of the developing devices 24 develops the electrostatic latent image formed on the outer peripheral surface of the corresponding photoconductor drum 21 with the developer G including toner, thus forming a toner image on the outer peripheral surface of the photoconductor drum 21. The developing device 24 includes at least a container 24A, and a developing roller 24B. The container 24A contains the developer G. The developing roller 24B supplies the developer G contained in the container 24A to the photoconductor drum 21 as the developing roller 24B rotates. The container 24A is connected with the toner cartridge 27 that supplies the developer G, by a supply path (not illustrated).

A developing bias voltage is applied to the developing roller 24B. A developing bias voltage is a voltage applied between the photoconductor drum 21 and the developing roller 24B. Application of a developing bias voltage produces a potential difference between the developing roller 24B and the photoconductor drum 21. This potential difference renders an electrostatic latent image on the photoconductor drum 21 into a visible image.

Cleaning Devices

Each of the cleaning devices 25 includes a blade 25A. The blade 25A scrapes off, from the surface of the photoconductor drum 21, any toner remaining on the surface of the photoconductor drum 21 after transfer of a toner image to the transfer device 30. Although not illustrated, the cleaning device 25 further includes a housing for collecting the toner scraped off by the blade 25A (see FIG. 3), and a transport device that transports toner in the housing to a waste toner box.

Transfer Device

The transfer device 30 performs first transfer and second transfer. In the first transfer, separate toner images created on the photoconductor drums 21 for individual colors are transferred to the transfer belt 31 in a superimposed manner. In the second transfer, the resulting composite superimposed toner image is transferred to the sheet member P (see FIG. 2).

As illustrated in FIG. 2, in one specific implementation, the transfer belt 31 is in endless form, and wound on multiple rollers 32. Of the rollers 32, a roller 32D illustrated in FIG. 2 serves as a drive roller that causes the transfer belt 31 to revolve in the direction of an arrow A with power supplied from a motor (not illustrated). Of the rollers 32, a roller 32T illustrated in FIG. 2 serves as a tension applying roller that applies tension to the transfer belt 31. Of the rollers 32, a roller 32B illustrated in FIG. 2 serves as a counter roller opposed to a second transfer roller 34.

The top side of the transfer belt 31 extending in the width direction of the apparatus contacts the photoconductor drums 21 corresponding to individual colors from below, so that an image (toner image) on each of the photoconductor drums 21 is transferred to the transfer belt 31 upon application of a transfer bias voltage from the corresponding one of first transfer rollers 33. The transfer belt 31 is in contact with the second transfer roller 34 at the bottom-side vertex that forms an obtuse angle. The area of this contact defines the transfer nip NT. The transfer belt 31 transfers a toner image to the sheet member P passing through the transfer nip NT, upon application of a transfer bias voltage from the second transfer roller 34.

Fixing Device

As illustrated in FIG. 2, the fixing device 40 fixes a toner image transferred to the sheet member P by the transfer device 30, onto the sheet member P. The fixing device 40 fixes a toner image to the sheet member P by applying heat and pressure to the toner image at a fixing nip NF defined between a fixing unit 41, which includes a fixing belt wound on multiple rollers (not illustrated), and a pressure roller 42. For example, at least one of the rollers (not illustrated) may be a heat roller that includes, for example, a heater in its inside, and rotates with the drive force transmitted from a motor (not illustrated). This configuration allows heat and pressure to be applied to the toner image to fix the toner image onto the sheet member P as the fixing unit 41 rotates in the direction of an arrow R illustrated in FIG. 2.

Medium Transport Unit

The medium transport unit 50 includes a medium supply unit 52 that supplies the sheet member P to the image forming unit 12, and a medium discharge unit 54 that discharges the sheet member P on which an image has been formed. The medium transport unit 50 also includes a medium return unit 56 used to form an image on both sides of the sheet member P, and an intermediate transport unit 58 that transports the sheet member P from the transfer device 30 to the fixing device 40.

The medium supply unit 52 supplies the sheet members P to the transfer nip NT of the image forming unit 12, one by one in synchronism with the transfer timing. The medium discharge unit 54 discharges the sheet member P on which an image has been formed by fixing of a toner image by the fixing device 40, to the outside of the apparatus. When an image is to be formed on the other side of the sheet member P with a toner image already fixed on one side, the medium return unit 56 reverses the front and back of the sheet member P and then returns the sheet member P to the image forming unit 12 (the medium supply unit 52).

Postprocessing Unit

As illustrated in FIG. 1, the postprocessing unit 60 includes a medium cooling unit 62 that cools the sheet member P on which an image has been formed by the image forming unit 12, a decurling device 64 that decurls the sheet member P, and an image inspection unit 66 that inspects the image formed on the sheet member P. The various constituent units of the postprocessing unit 60 are disposed in the medium discharge unit 54 of the medium transport unit 50.

The medium cooling unit 62, the decurling device 64, and the image inspection unit 66, which are components of the postprocessing unit 60, are disposed in the stated order from the upstream side in the direction of discharge of the sheet member P in the medium discharge unit 54, and apply postprocessing to the sheet member P as the sheet member P is discharged by the medium discharge unit 54.

Image Forming Operation

The following description provides an overview of formation of an image on the sheet member P, and postprocessing that are performed by the image forming apparatus 10.

As illustrated in FIG. 1, upon receiving an instruction to form an image, the controller 70 activates components such as the toner image forming unit 20, the transfer device 30, the fixing device 40, and the medium transport unit 50.

Thus, the photoconductor drum 21 corresponding to each individual color is charged by the charging unit 22 as the photoconductor drum 21 rotates. Although described later in detail, the controller 70 sends image data on which image adjustments such as image processing have been performed, to each of the exposure devices 23. Each of the exposure devices 23 emits the corresponding exposure light L in accordance with the image data, thus exposing the corresponding charged photoconductor drum 21 to the exposure light L. This exposure creates an electrostatic latent image on the outer peripheral surface of each of the photoconductor drums 21. The electrostatic latent image formed on each of the photoconductor drums 21 is developed with the developer G supplied from the corresponding developing device 24. As a result, a toner image in one of the colors including special color (V), yellow (Y), magenta (M), cyan (C), and black (K) is formed on the photoconductor drum 21 corresponding to each individual color.

The separate toner images in individual colors formed on the photoconductor drums 21 corresponding to individual colors are sequentially transferred to the transfer belt 31 in a superimposed manner, forming a composite superimposed toner image on the transfer belt 31. The composite superimposed toner image is transported to the transfer nip NT. At the transfer nip NT, the sheet member P is supplied in synchronism with this transport, and thus the composite superimposed toner image is transferred from the transfer belt 31 to the sheet member P. To print on the paper specified by an input print job J, the controller 70 causes the sheet member P accommodated in one of the first accommodating unit 14, the second accommodating unit 15, and the third accommodating unit 16 to be transported. The sheet member P with the composite superimposed toner image transferred thereto is transported by the intermediate transport unit 58 from the transfer nip NT toward the fixing nip NF of the fixing device 40. At the fixing nip NF, the composite superimposed toner image transferred to the sheet member P is fixed onto the sheet member P by the fixing device 40.

After exiting the fixing device 40, the sheet member P undergoes a series of processing by the postprocessing unit 60 as the sheet member P is transported by the medium discharge unit 54 toward a discharged medium receiving unit located outside the apparatus. The sheet member P heated by the fixing process is cooled by the medium cooling unit 62, and then decurled by the decurling device 64. Further, the image fixed to the sheet member P is inspected by the image inspection unit 66 for the presence or degrees of defects such as a toner density defect, an image defect, and an image position defect. Then, the sheet member P is discharged to the medium discharge unit 54.

To form an image on the non-image side of the sheet member P on which no image has been formed (that is, in the case of duplex printing), the controller 70 changes the path along which the sheet member P is to be transported after passing through the image inspection unit 66, from the medium discharge unit 54 to the medium return unit 56. Thus, the front and back of the sheet member P are reversed, and the resulting sheet member P is sent to the medium supply unit 52. An image is formed (fixed) on the back side of the sheet member P through a process similar to the above-mentioned process that forms an image on the front side of the sheet member P. The sheet member P is discharged to the outside of the apparatus by the medium discharge unit 54 through a process similar to the postprocessing process performed after an image is formed on the front side of the sheet member P.

Next, the controller 70 will be described. The controller 70 controls various units of the image forming apparatus 10. The controller 70 acts as a first controller and a second controller to form an image adjusted using calibration information (adjustment information) associated with the sheet member P of interest and related to adjustment of at least one of the position, color, and tone of an image.

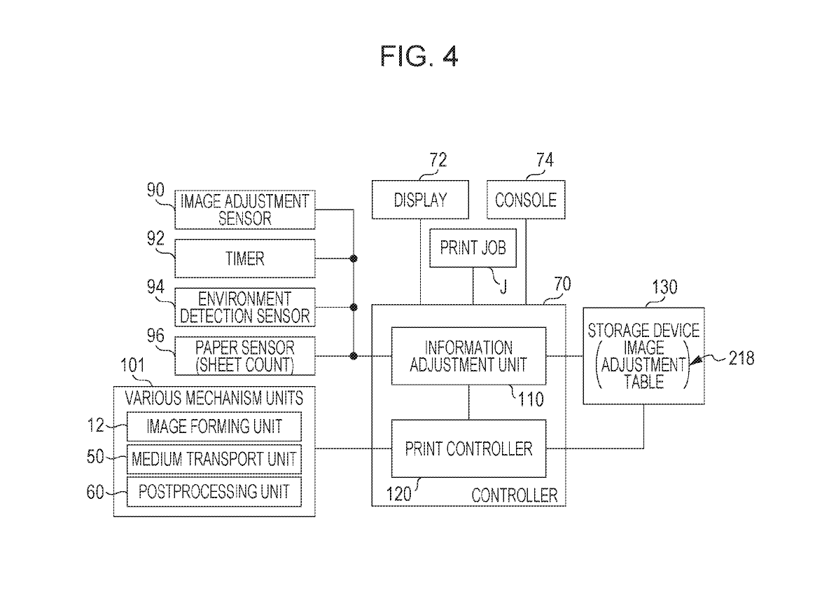

FIG. 4 illustrates the controller 70 according to the first exemplary embodiment. The controller 70 includes an information adjustment unit 110, and a print controller 120. The information adjustment unit 110 is connected with a storage device 130 in which an image adjustment table 218 is stored. The image adjustment table 218 stores information related to adjustments made when the image forming apparatus 10 forms an image on the sheet member P (details of which will be given later). The storage device 130 in which the image adjustment table 218 is stored may be provided outside the controller 70. The information adjustment unit 110 and the print controller 120 are connected so as to be able to exchange information with each other. The information adjustment unit 110 is connected with the image adjustment sensor 90, and the timer 92. The information adjustment unit 110 is connected with the environment detection sensor 94 that detects the ambient or internal environment of the image forming apparatus 10, and the paper sensor 96 that counts the number of sheet members P on which an image has been formed (printed). The information adjustment unit 110 may store, as a cumulative number of sheet members P, the number of sheet members P detected by the paper sensor 96. The environment detection sensor 94 is able to obtain information indicative of changes of the image forming apparatus 10 over time, based on the environment detected by the environment detection sensor 94 and based on information detected in time series by the paper sensor 96. The print controller 120 is connected with various mechanism units 101 of the image forming apparatus 10, including the image forming unit 12, the medium transport unit 50, and the postprocessing unit 60.

The information adjustment unit 110 performs an information adjustment process including storage and updating of calibration information (adjustment information) related to image adjustments made at the time of forming an image on the sheet member P. That is, for each accommodating unit, the information adjustment unit 110 stores information related to image adjustments made at the time of forming an image on the sheet member P, into the image adjustment table 218 or updates this information, based on a sensor output value detected by at least one of the image adjustment sensor 90, the timer 92, the environment detection sensor 94, and the paper sensor 96.

The print controller 120 performs print control on the image forming apparatus 10. This print control includes image processing that converts an input image into a printable format, and printing that prints the image on which this image processing has been performed. That is, in order to execute image formation, the print controller 120 controls the various mechanism units 101 of the image forming apparatus 10, including the image forming unit 12, the medium transport unit 50, and the postprocessing unit 60. The print controller 120 executes a process of forming, on paper, an image adjusted using information stored in the image adjustment table 218. In an alternative configuration, the environment detection sensor 94 and the paper sensor 96 connected to the information adjustment unit 110 are connected to the print controller 120, and the information adjustment unit 110 acquires the output values of the environment detection sensor 94 and the paper sensor 96 from the print controller 120.

In the image forming apparatus 10, image-related adjustments (calibrations) are performed at the time of forming an image on the sheet member P in order to minimize a decrease in image quality due to, for example, tone unevenness, color unevenness, or image misalignment. Examples of calibrations include tone correction that corrects tone unevenness, color unevenness correction that corrects color unevenness, and alignment correction that corrects image misalignment.

Tone correction converts input image data into corrected image data corrected for printing in a correct tone. In one specific exemplary configuration, the following print pattern is printed first. This print pattern includes multiple tone patches each representing the partial image data of the tone (from low density to high density) of each individual color that serves as a reference. Then, the densities of individual tone patches printed are detected. Next, statistical processing is performed on the detected densities of individual tone patches and the densities at which individual colors are to be printed based on the partial image data, and the relationship between the density of each individual tone patch printed, and the density based on the partial image data is determined. That is, the relationship between input image data, and tone-corrected image data is determined as conversion characteristics, so that each individual tone patch is printed at the density at which each individual color is to be printed based on the partial image data of each individual color serving as a reference. The determined conversion characteristics are stored in the form of a tone correction table. As a result, input image data is converted into tone-corrected image data so that individual colors are printed at densities at which these colors are to be printed based on the tone correction table. Thus, images of individual colors are printed at the densities for the corresponding colors.

Color unevenness correction converts input image data into corrected image data corrected for printing in a manner that reduces color unevenness, which is the partial loss of color uniformity. In one specific exemplary configuration, multiple color strip patterns are printed for each of individual colors serving as a reference, and the density at a predetermined point within each of the printed color strip patterns is detected. Next, statistical processing is performed on the amounts of change in the density of each predetermined point detected for each individual color strip pattern, and the characteristics of density variation for each individual color strip pattern printed are determined. The determined characteristics of density variation are stored in the form of a color-unevenness correction table. As a result, input image data is converted into corrected image data corrected for color unevenness based on the color-unevenness correction table to ensure uniformity of each individual color. Thus, images of individual colors are printed with reduced color unevenness.

In alignment correction, an image to be printed on the sheet member P based on input image data is corrected so that the image is printed within a predetermined printing area on the sheet member P. In one specific exemplary configuration, a predetermined grid pattern is printed, and the positions of individual grid points in the printed grid pattern are detected. Next, statistical processing is performed on the detected positions of individual grid points and the positions at which individual grid points are to be printed in the grid pattern, and the relationship between the position of each individual grid point printed, and the position at which each individual grid point is to be printed in the grid pattern is determined. That is, in order to ensure that individual grid points in a predetermined grid pattern be printed at appropriate positions on the sheet member P, statistical processing is performed on the amounts of misalignment of individual detected grid points to determine misalignment characteristics for the printed grid pattern. The determined misalignment characteristics are stored in the form of an alignment correction table. As a result, input image data is corrected in position for printing at an appropriate position according to the alignment correction table. Thus, images of individual colors are printed with reduced misalignment.

The image forming apparatus 10 stores the tone correction table, the color-unevenness correction table, and the alignment correction table as calibration information to perform these image-related adjustments (calibrations), and uses the stored calibration information when forming an image on the sheet member P.

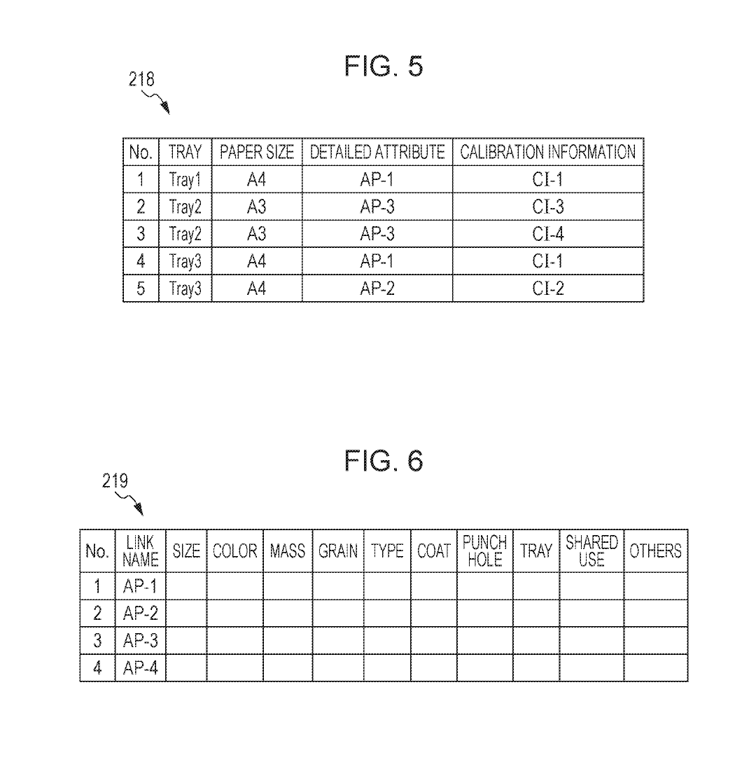

FIG. 5 illustrates the image adjustment table 218. The image adjustment table 218 tabulates various pieces of information related to image adjustments performed in the image forming apparatus 10. As illustrated in FIG. 5, the image adjustment table 218 stores the following pieces of information in association with each other: tray information, paper size information, detailed attribute information, and calibration information.

The tray information illustrated in FIG. 5 corresponds to identification information for identifying each individual accommodating unit. The paper size information, and the detailed attribute information correspond to attribute information. Further, the calibration information corresponds to adjustment information. In the following, a group of information including identification information (tray information), attribute information (paper size information and detailed attribute information), and adjustment information (calibration information) that are associated with each other will be referred to as stock information, which is an example of related information.

The tray information is information that enables identification of each individual accommodating unit accommodating the sheet member P. In FIG. 5, as the associated tray information, Tray1, Tray2 and Tray3 respectively representing the first accommodating unit 14, the second accommodating unit 15, and the third accommodating unit 16 equipped to the image forming apparatus 10 are stored.

Of the attribute information indicating the properties of the sheet member P accommodated in the accommodating unit of interest, the paper size information indicates the size of the sheet member P. The detailed attribute information indicates the detailed attribute information of the sheet member P accommodated in the accommodating unit of interest. In FIG. 5, as the associated detailed attribute information, information indicating the storage location (link address) of tabulated detailed attribute information is stored.

Stock Information No. 1 and Stock Information No. 4 in FIG. 5 indicate that identical types of sheet members P are accommodated in the first accommodating unit 14 and the third accommodating unit 16, with the same calibration information associated with these sheet members P. Stock Information No. 2 and Stock Information No. 3 in FIG. 5 indicate that the same type of sheet member P accommodated in the second accommodating unit 15 is associated with different pieces of calibration information that differ in, for example, the number of colors. Further, Stock Information No. 5 in FIG. 5 indicates that the sheet member P with detailed attributes different from those of the above-mentioned sheet members P is accommodated in the third accommodating unit 16, and that the calibration information corresponding to this sheet member P is associated with the sheet member P.

FIG. 6 illustrates an attribute information table 219 tabulating various pieces of information, which is an example of the detailed attribute information of the sheet member P. As illustrated in FIG. 6, in the attribute information table 219, Link Name, and various pieces of information included in the attribute information indicating the properties of the sheet member P, such as Size, Color, Mass, Grain, Type, Coat, Punch Hole, Tray, Shared Use, and Others, are registered in association with each other. The “Link Name” is information indicating the storage location (link address) that enables identification of each individual piece of detailed attribute information registered in the image adjustment table 218.

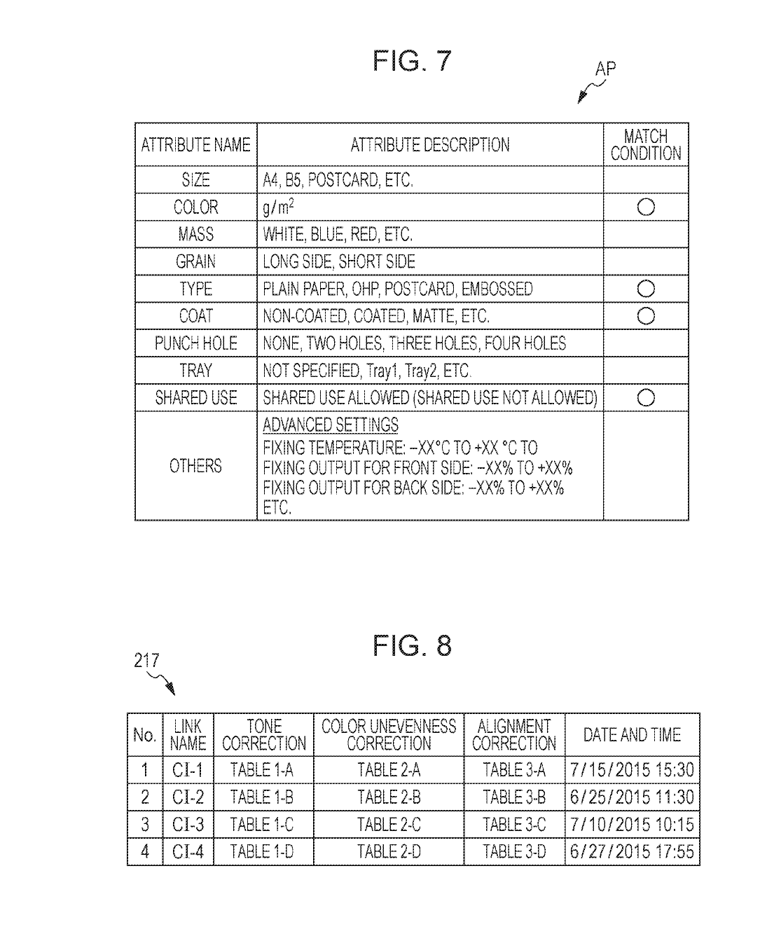

FIG. 7 illustrates a specific example of attribute information as an attribute list AP. In the attribute list AP illustrated in FIG. 7, each of the following pieces of information: “Attribute Name”, “Attribute Description”, and “Match Condition”, is associated with individual pieces of information included in the attribute information. The “Attribute Name” indicates information for identifying each individual piece of information included in the attribute information. The “Attribute Description” provides a description of information that can be indicated by the information identified by the “Attribute Name”. Further, the “Match Condition” indicates information represented by each attribute name that is specified to regard two or more sheet members P as similar. That is, if the information value of information indicated by an attribute name specified by the Match Condition matches between the attribute information of a given sheet member P and the attribute information of another sheet member P, such two sheet members P are regarded as similar sheet members.

Of the various pieces of information indicating attribute names, the “Size” is information indicating the size of the sheet member P, and can take information values such as A4, B5, and Postcard. The “Color” is information indicating the color of the sheet member P, and can take information values such as White, Blue, and Red. The “Mass” is information indicating the mass of the sheet member P. The “Grain” is information indicating the grain of the sheet member P, and can take information values such as Long Side and Short Side. The “Type” is information indicating the type of the sheet member P, and can take information values such as Plain Paper, OHP, Postcard, and Embossed. The “Coat” is information indicating the surface condition of the sheet member P, and can take information values such as Non-Coated, Coated, and Matte. The “Punch Hole” is information indicating machining applied to the sheet member P, and can take information values such as None, Two Holes, Three Holes, and Four Holes. The “Tray” is information indicating an accommodating unit accommodating the sheet member P, and can take information values such as Not Specified, Tray1, Tray2, and Tray3. The “Shared Use” is information indicating shared use of the sheet member P. This information indicates whether the attribute information of interest can be regarded as similar to another piece of attribute information so that the sheet member P with the attribute information of interest can be handled in the same manner as the sheet member P with the other similar piece of attribute information. The “Shared Use” can take information values such as Shared Use Allowed. The “Others” is information indicating advanced settings, and can take information values that allow settings of values including the upper and lower limits (temperatures) of the fixing temperature, the upper and lower limits (%) of the fixing output for the front side, and the upper and lower limits (%) of the fixing output for the back side.

As illustrated in FIG. 5, in the stock information stored in the image adjustment table 218, calibration information is associated with tray information.

FIG. 8 illustrates a calibration table 217 as a specific example of calibration information. The calibration table 217 includes information tabulating each of the following pieces of information (data): tone correction, color unevenness correction, and alignment correction. As illustrated in FIG. 8, information indicating the link name for identifying each individual piece of calibration information is associated with calibration information and with information indicating date. That is, in the calibration table 217, information indicating link name is associated with each of the pieces of calibration information indicating tone correction, color shading correction, and alignment correction, and further with information indicating the date and time of storage or update of these pieces of information.

In FIG. 8, as each of the associated pieces of information indicating tone correction, color unevenness correction, and alignment correction, information indicating storage location (link address) is stored. This information indicates the location in which tabulated characteristics representing each of the pieces of information indicating tone correction, color unevenness correction, and alignment correction are stored is an identifiable manner. That is, as the information indicating tone correction, the following tone correction table is stored. This tone correction table tabulates the conversion characteristics for converting input image data into corrected image data corrected for printing in a correct tone. As the information indicating color unevenness correction, the following color-unevenness correction table is stored. This color-unevenness correction table tabulates the density variation characteristics for converting input image data into corrected image data corrected for printing in a manner that reduces color unevenness, which is the partial loss of color uniformity. As the information indicating alignment correction, the following alignment correction table is stored. This alignment correction table tabulates the characteristics of alignment correction for correcting alignment so that an image to be printed on the sheet member P based on input image data is printed within a predetermined printing area on the sheet member P.

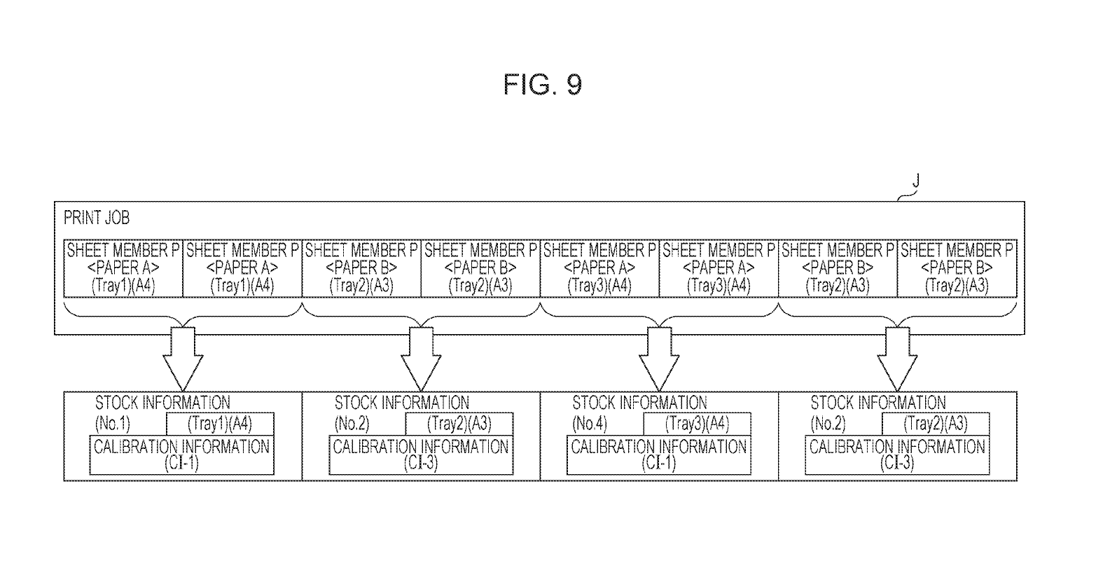

FIG. 9 illustrates an example of a print job J input to the controller 70. The print job J illustrated in FIG. 9 indicates that images are formed sequentially on the sheet members P specified as follows: two sheets of Paper A in A4 size accommodated in the first accommodating unit 14, two sheets of Paper B in A3 size accommodated in the second accommodating unit 15, two sheets of Paper A in A4 size accommodated in the third accommodating unit 16, and then two sheets of Paper B in A3 size accommodated in the second accommodating unit 15. Tray information, which indicates the accommodating unit accommodating each individual sheet member P specified as each individual type of paper, is associated with calibration information. The controller 70 causes an image to be formed by using the calibration information corresponding to the accommodating unit accommodating each specified sheet member P. In this way, when the accommodating unit to be used is changed following a change of the sheet member P, an image is then formed using the calibration information corresponding to the changed accommodating unit.

The controller 70 illustrated in FIG. 4 can be implemented by, for example, a computer.

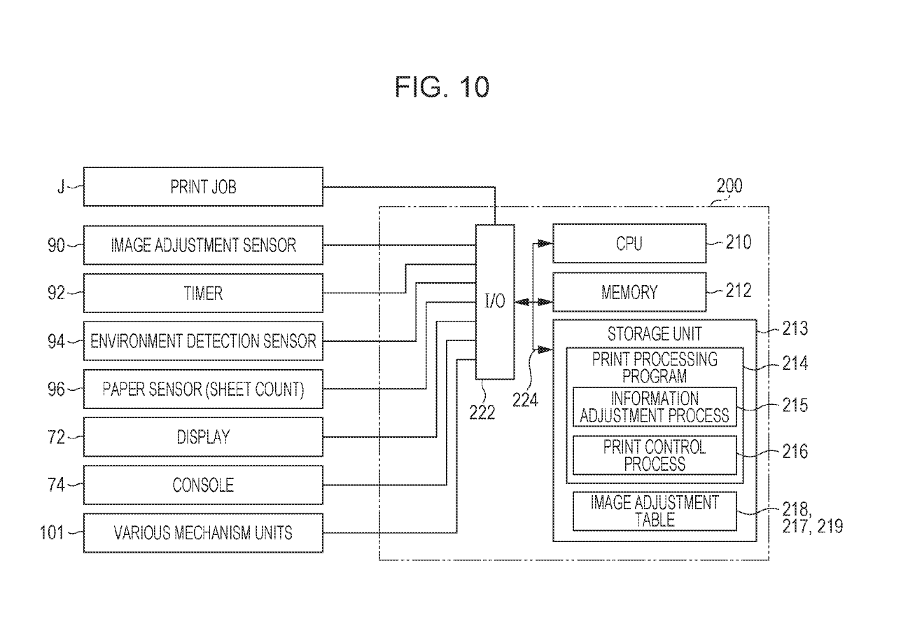

FIG. 10 illustrates a computer 200 as an example of a computer capable of implementing the controller 70. The computer 200 includes a CPU 210, a memory 212, a non-volatile storage unit 213, and an input/output port (I/O) 222. These components are connected to each other via a bus 224. The I/O 222 is connected to the image adjustment sensor 90, the timer 92, the environment detection sensor 94, the paper sensor 96, the display 72, the console 74, and the various mechanism units 101 of the image forming apparatus 10.

The storage unit 213 can be implemented by, for example, a hard disk drive (HDD), or a flash memory. The storage unit 213 as a recording medium stores a print processing program 214, and the image adjustment table 218. The print processing program 214 causes the computer 200 to function as the controller 70. The print processing program 214 includes an information adjustment process 215, and a print control process 216. The CPU 210 reads the print processing program 214 from the storage unit 213, and develops the print processing program 214 to the memory 212 to execute the information adjustment process 215 and the print control process 216. Thus, the computer 200 executing the print processing program 214 acts as the controller 70 illustrated in FIG. 4.

That is, the controller 70 is implemented by the computer 200. As the CPU 210 executes the information adjustment process 215 included in the print processing program 214, the computer 200 is caused to operate as the information adjustment unit 110 illustrated in FIG. 4. Further, as the CPU 210 executes the print control process 216 included in the print processing program 214, the computer 200 is caused to operate as the print controller 120 illustrated in FIG. 4.

Next, operation of the computer 200 that functions as the controller 70 will be described. The following description will be directed to a case in which the print job J illustrated in FIG. 9 is input to the computer 200.

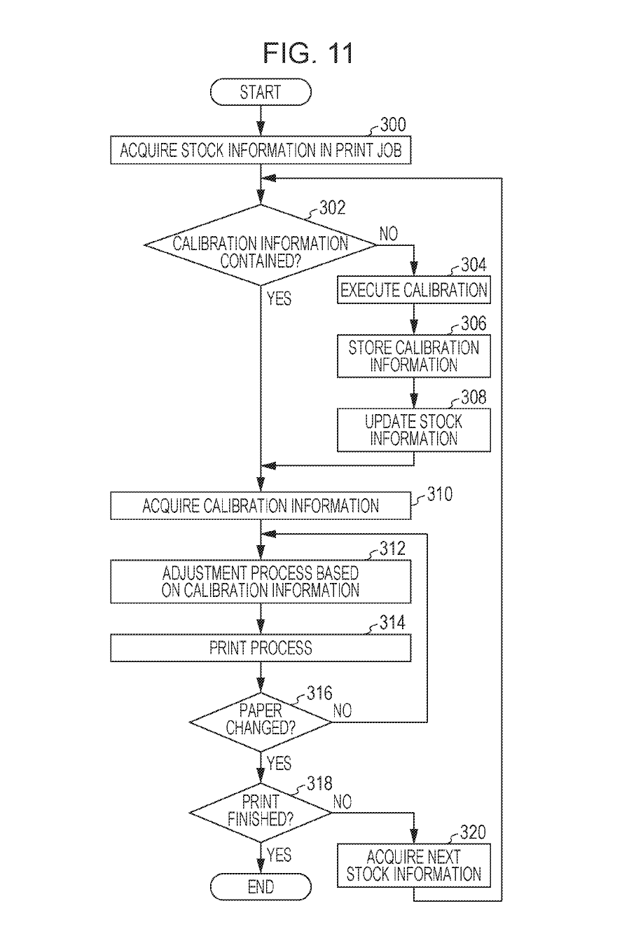

FIG. 11 illustrates an exemplary print procedure executed in the computer 200 that functions as the controller 70 when the print processing program 214 is executed by the CPU 210. The CPU 210 executes the process routine illustrated in FIG. 11 upon receiving an input of the print job J.

First, in step 300, the CPU 210 acquires stock information in the print job J. In step 300, the CPU 210 acquires the first stock information in the print job J that has been input. Tray information is specified for the print job J. The tray information specified at this time indicates the accommodating unit that accommodates as the target paper on which to print, at least the sheet member P on which to form an image. The CPU 210 references the image adjustment table 218 (FIG. 5) stored in the storage unit 213, and acquires the stock information corresponding to the tray information indicating the accommodating unit specified for the first print process in the print job J. That is, Stock Information No. 1 is acquired in the example illustrated in FIG. 9.

If there are multiple pieces of stock information corresponding to tray information indicating an accommodating unit in the image adjustment table 218, stock information may be used instead of tray information indicating an accommodating unit. In this case, the user may specify one of the multiple pieces of stock information in advance for the print job J.

In the next step 302, it is determined whether tray information indicating an accommodating unit in the acquired stock information is associated with calibration information, thus determining whether calibration information exists. If step 302 results in a negative determination, the processing is transferred to step 304. If step 302 results in a positive determination, the processing is transferred to step 310. In the present case (in the example illustrated in FIG. 9), calibration information exists for Stock Information No. 1. Thus, the processing is transferred to step 310.

If stock information contains no associated calibration information, this results in a negative determination in step 302. Then, in step 304, calibration is executed. In the next step 306, the resulting calibration information is stored. In the next step 308, the stock information is updated, and then the processing is transferred to step 310.

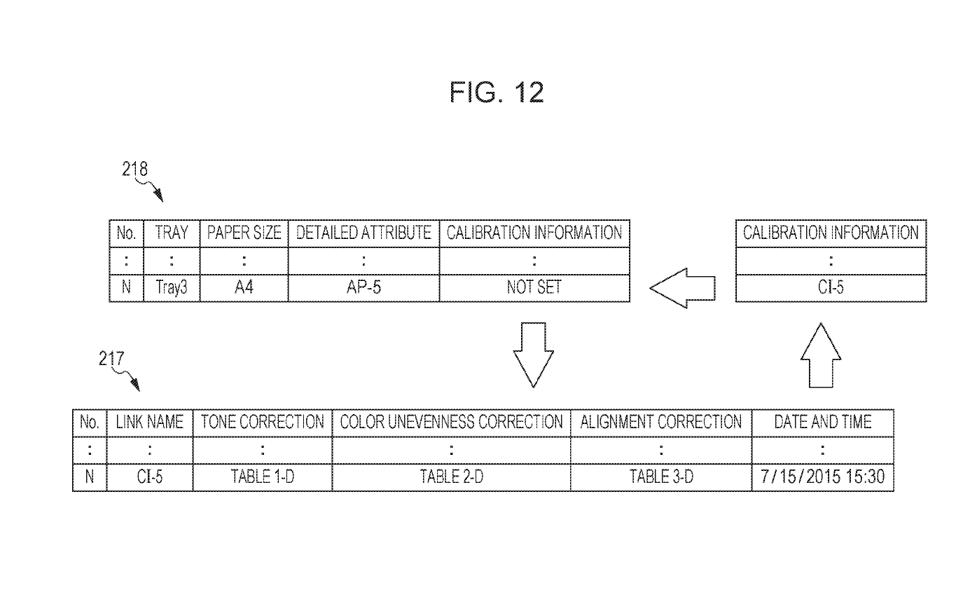

FIG. 12 illustrates an exemplary process in which, when stock information contains no associated calibration information, calibration information is obtained for this stock information and registered into the image adjustment table 218. If stock information (N) in the image adjustment table 218 contains no associated calibration information, the image forming apparatus 10 executes calibration. That is, in step 304, the CPU 210 causes an image to be printed on the sheet member P, controls the image adjustment sensor 90 to detect information such as tone, color, and position for an image formed on the sheet member P, and uses the detected information to perform tone correction, color unevenness correction, and alignment correction. Next, in step 306, the CPU 210 stores the results of these corrections into the calibration table 217 as calibration results. That is, the CPU 210 stores a tone correction table, a color-unevenness correction table, and an alignment correction table into the calibration table 217 as calibration information in association with a link name. In the next step 308, the link name stored into the calibration table 217 is registered into the field of calibration information in the image adjustment table 218, thus updating the corresponding stock information.

Next, in step 310 illustrated in FIG. 11, the image adjustment table 218 is referenced to acquire calibration information in the stock information of the print job J. In the next step 312, the acquired calibration information is used to perform image adjustments (tone correction, color unevenness correction, and alignment correction). In the next step 314, a print process that forms an image on the sheet member P is executed. In the next step 316, it is determined whether it is instructed to change the paper for the next print process in the print job J, and if this results in a negative determination, the processing returns to step 312, and a print process is performed which forms an image on the next sheet member P that is a sheet of paper with the same attribute information.

If step 316 results in a positive determination, then in step 318, it is determined whether the print process based on the last print instruction in the print job is finished to determine whether printing is finished. If step 318 results in a positive determination, the process routine is ended. If the CPU 210 makes a negative determination in step 318, then in step 320, as in step 300, the CPU 210 acquires the next stock information in the print job J, and then returns to step 302 to continue the processing.

The process through steps 302 to 308 illustrated in FIG. 11 corresponds to the computer 200 executing the information adjustment process 215 to function as the information adjustment unit 110 of the controller 70. The functioning of the computer 200 as the information adjustment unit 110 of the controller 70 corresponds to the operation of the computer 200 as the first controller in the controller 70. Further, the process through steps 310 to 320 in FIG. 11 corresponds to the computer 200 executing the print control process 216 to function as the print controller 120 of the controller 70. The functioning of the computer 200 as the print controller 120 of the controller 70 corresponds to the operation of the computer 200 as the second controller in the controller 70.

### Second Exemplary Embodiment

Next, a second exemplary embodiment will be described. Since the second exemplary embodiment is of substantially the same configuration as the first exemplary embodiment, portions identical to those in the first exemplary embodiment are denoted by the same symbols to omit a detailed description of such portions.

In the first exemplary embodiment, for stock information that contains no associated calibration information, calibration information is executed to obtain calibration information, and the obtained calibration information is used to update this stock information (steps 302 to 306 illustrated in FIG. 11). In the second exemplary embodiment, calibration information obtained by executing calibration is also used as calibration information for stock information with similar attribute information to update the stock information.

Next, operation of the computer 200 that functions as the controller 70 according to the second exemplary embodiment will be described.

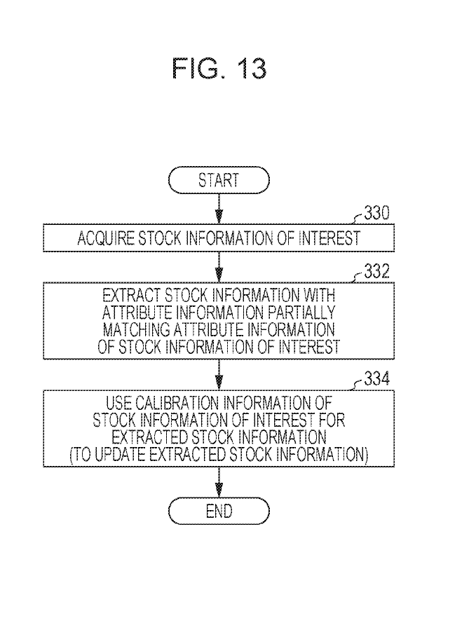

FIG. 13 illustrates a procedure according to the second exemplary embodiment for updating stock information having similar attribute information in the computer 200 that acts as the controller 70 by execution of the print processing program 214 by the CPU 210. The steps in FIG. 13 are executed instead of step 308 in the process routine illustrated in FIG. 11.

First, in step 330, the CPU 210 acquires the stock information of interest. The stock information acquired at this time is stock information with which no calibration information is previously associated and for which calibration information has been acquired and stored by execution of calibration. In the next step 332, the CPU 210 references the image adjustment table 218, and extracts stock information with attribute information that partially matches the attribute information in the stock information of interest, as the stock information for which the same calibration information as that in the stock information of interest can be used. In step 332, the CPU 210 extracts stock information corresponding to a sheet member P similar to the sheet member P corresponding to the stock information of interest. At this time, the CPU 210 regards a sheet member P as similar if the sheet member P has attribute information such that the information value of information indicated by an attribute name specified by the “Match Condition” in the attribute list AP (see FIG. 7) matches that in the attribute information of the stock information of interest. In step 332, at least the stock information of interest is extracted. In the next step 334, the same calibration information as the calibration information in the stock information of interest is also used for the stock information extracted in step 332 to update the extracted stock information.

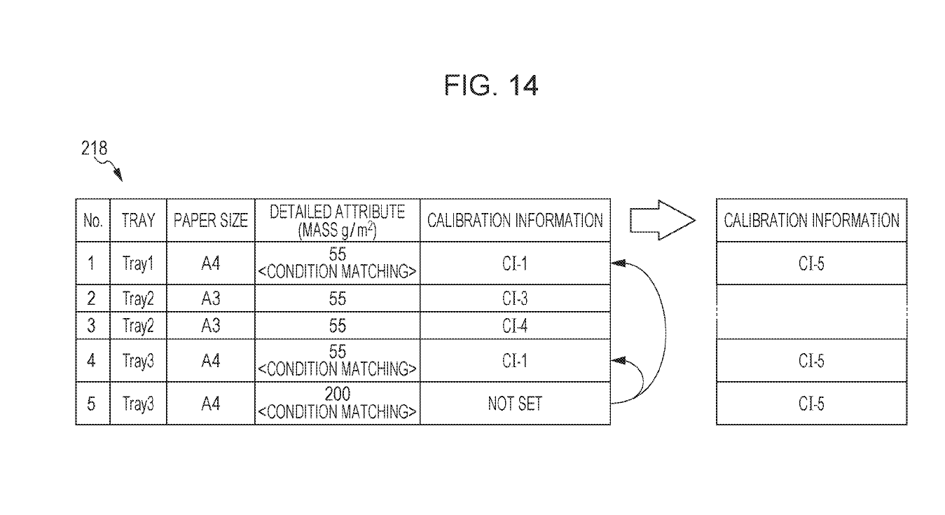

FIG. 14 illustrates how the same calibration information as the calibration information in the stock information of interest is also used for the stock information with similar attribute information. FIG. 14 illustrates that Stock Information No. 5 is the stock information of interest for which no calibration information has been set. For this stock information of interest, Stock Information No. 1 and Stock Information No. 4 are regarded as similar stock information based on the “Match Condition”. That is, when calibration information is obtained and stored for Stock Information No. 5, which is the stock information of interest, into the calibration table 217 as Link Name CI-5, the field of calibration information in each of Stock Information No. 1 and Stock Information No. 4 is updated with Link Name CI-5.

In the second exemplary embodiment, calibration information obtained by executing calibration for stock information previously containing no associated calibration information is also used for stock information with similar attribute information to update such stock information. However, the stock information of interest whose calibration information obtained by calibration is used to update the stock information having attribute information similar to that of the stock information of interest is not limited to stock information previously containing no associated calibration information. For example, when the user updates calibration information for a specific piece of stock information, calibration information may be updated for stock information with similar attribute information. In this case, the process routine illustrated in FIG. 13 may be executed when the user updates calibration information for a specific piece of stock information.

### Third Exemplary Embodiment

A third exemplary embodiment of the present invention will be described below. Since the third exemplary embodiment is of substantially the same configuration as the first and second exemplary embodiments, portions identical to those in the first and second exemplary embodiments are denoted by the same symbols to omit a detailed description of such portions.

In the second exemplary embodiment above, for stock information containing no associated calibration information, calibration information is obtained by executing calibration, and the obtained calibration information is associated with this stock information. In the third exemplary embodiment, the existing calibration information is updated at predetermined timing to ensure that calibration information, which varies with time or with changing environmental conditions, be maintained in an appropriate manner.

Hereinafter, operation of the computer 200 that functions as the controller 70 according to the third exemplary embodiment will be described.

The third exemplary embodiment defines operating states of the image forming apparatus 10 that allow calibration information to be maintained and continuously used in the image forming apparatus 10. These operating states of the image forming apparatus 10 are used in making a determination of whether to update calibration information described later. The third exemplary embodiment defines first to fourth operating states described below as a specific example of the operating states of the image forming apparatus 10. The first operating state refers to an operating state of the image forming apparatus 10 in which the time that has elapsed since the execution of calibration in the image forming apparatus 10, that is, since the storage of calibration information into the image adjustment table 218 is within a predetermined range. The second operating state refers to an operating state of the image forming apparatus 10 in which the image forming apparatus 10 is operated within a predetermined environmental range. The third exemplary embodiment defines the predetermined environmental range as, for example, at least one of a predetermined environmental temperature range and a predetermined environmental humidity range. The third operating state refers to an operating state of the image forming apparatus 10 in which maintenance, such as replacement or routine maintenance of components mounted in the image forming apparatus 10 and related to image formation, has not been performed. The fourth operating state refers to an operating state of the image forming apparatus 10 in which the number (cumulative number) of sheet members P on which an image has been formed is within a predetermined range.

In the third exemplary embodiment, a predetermined update condition is regarded as satisfied when the operating state of the image forming apparatus 10 deviates from one of the first to fourth operating states, and then calibration information is updated. That is, a first update condition is regarded as satisfied when the time that has elapsed since the storage of calibration information into the image adjustment table 218 exceeds a predetermined time. A second update condition is regarded as satisfied when the operating environment of the image forming apparatus 10 deviates from a predetermined environmental range (at least one of a predetermined environmental temperature range and a predetermined environmental humidity range). A third update condition is regarded as satisfied when maintenance, such as replacement or routine maintenance of components mounted in the image forming apparatus 10 and related to image formation, is performed. A fourth update condition is regarded as satisfied when the number (cumulative number) of sheet members P on which an image has been formed exceeds a predetermined number.

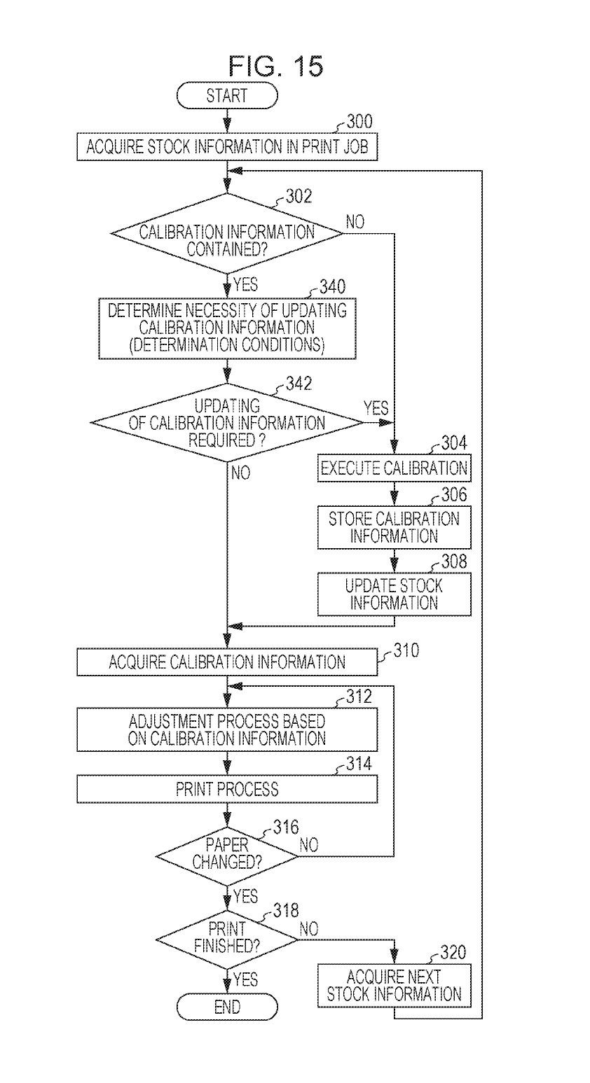

FIG. 15 illustrates a print procedure according to the third exemplary embodiment executed by the computer 200 that functions as the controller 70 when the print processing program 214 is executed by the CPU 210. The process routine illustrated in FIG. 15 has steps 340 and 342 added after a positive determination is made in step 302 in the process routine illustrated in FIG. 11.

When the CPU 210 determines for the stock information of interest (the first stock information) in the print job J that its tray information, which indicates an accommodating unit, contains associated calibration information (step 300, a positive determination in step 302), the processing is transferred to step 340. In step 340, a process to determine the necessity of updating calibration information is performed. Then, in the next step 342, it is determined whether to update calibration information based on the result of the update necessity determination. If step 342 results in a negative determination, the processing is transferred to step 304. If step 342 results in a positive determination, the processing is transferred to step 310.

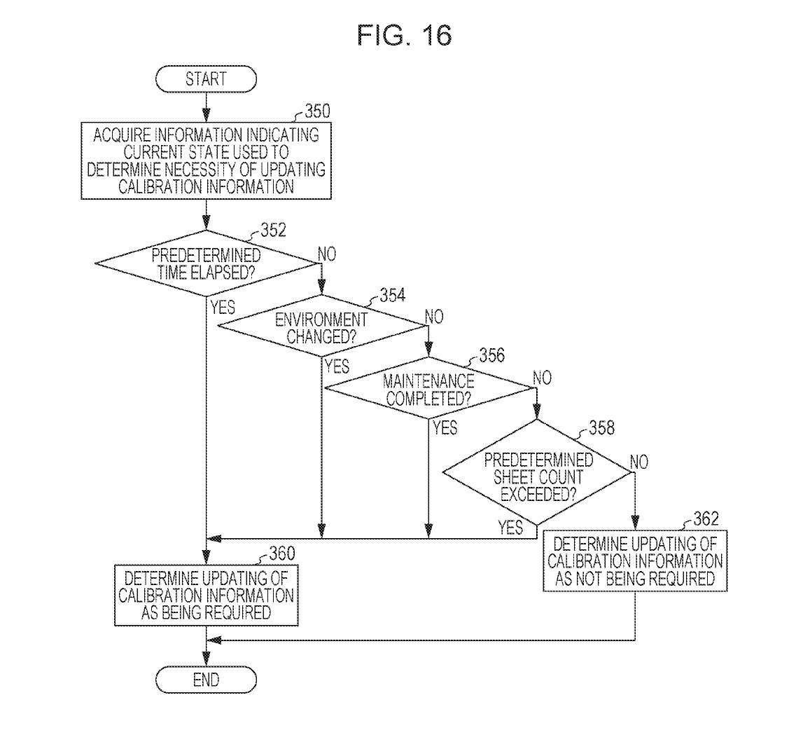

FIG. 16 illustrates a procedure according to the third exemplary embodiment for determining the necessity of updating. In step 340 illustrated in FIG. 15, the CPU 210 executes the procedure for determining the necessity of updating illustrated in FIG. 16.

First, in step 350, information indicating the current state of the image forming apparatus 10 is acquired for determining the necessity of updating calibration information. Specifically, information indicating the current operating state of the image forming apparatus 10 is acquired. That is, the first current operating state is acquired as the time that has elapsed since the storage of calibration information into the image adjustment table 218, based on information indicating date and time stored in the calibration table 217 (FIG. 8), and based on information indicating the current date and time obtained by the timer 92. The second current operating state is acquired as information indicating at least one of the environmental temperature and the environmental humidity detected by the environment detection sensor 94. The third current operating state is acquired as information indicating whether maintenance such as replacement or routine maintenance of components of the image forming apparatus 10 has been performed. The fourth current operating state is acquired as information indicating the number (cumulative number) of sheet members P on which an image has been formed (printed) as detected by the paper sensor 96.

In the next step 352, it is determined whether the first update condition is satisfied. That is, it is determined whether the elapsed time acquired in step 350 (first current operating state) exceeds a predetermined time. If the elapsed time exceeds a predetermined time, a positive determination is made in step 352, and it is determined in step 360 that updating of calibration information is required. Then, the present process routine is ended. If the elapsed time falls within a predetermined time, a negative determination is made in step 352, and the processing is transferred to step 354. In step 354, it is determined whether the second update condition is satisfied. That is, in order to determine whether there has been a change in environment, it is determined whether at least one of the environmental temperature and the environmental humidity acquired in step 350 (second current operating state) exceeds a predetermined environmental temperature range or a predetermined environmental humidity range. If there has been a change in environment, and step 354 results in a positive determination, the processing transfers to step 360. If there has been no change in environment, and step 354 results in a negative determination, the processing transfers to step 356.

In step 356, it is determined whether the third update condition is satisfied. That is, it is determined whether the state of the image forming apparatus 10 acquired in step 350 (third current operating state) indicates completion of maintenance. If maintenance has been performed, and step 356 results in a positive determination, the processing transfers to step 360. If maintenance has not been performed, and step 356 results in a negative determination, the processing transfers to step 358. In step 358, it is determined whether the fourth update condition is satisfied. That is, it is determined whether the number of sheet members P printed which is acquired in step 350 (fourth current operating state) exceeds a predetermined number. If the number of sheet members printed exceeds a predetermined number, a positive determination is made in step 358, and the processing is transferred to step 360. If the number of sheet members printed falls within a predetermined number, a negative determination is made in step 358, and it is determined in step 362 that updating of calibration information is not required. Then, the present process routine is ended.

That is, updating of calibration information is determined to be required if one of the first to fourth update conditions is satisfied. Updating of calibration information is determined to be not required if none of the first to fourth update conditions is satisfied.

Although the third exemplary embodiment is directed to a case in which the existing calibration information is updated at a predetermined timing prior to execution of printing, the timing of update according to exemplary embodiments of the present invention is not limited to this timing. For example, in an alternative configuration, the operating state of the image forming apparatus 10 is detected periodically or at predetermined timing, and calibration information is updated if the detected operating state deviates from a predetermined operating state. In this case, in the process routine illustrated in FIG. 16, calibration (steps 304 to 308 illustrated in FIG. 11) may be executed in step 360, and step 362 may be omitted so that the process routine is executed periodically or at predetermined timing.

Although specific exemplary embodiments of the present invention have been described above in detail, the present invention is not limited to the above exemplary embodiments but may be implemented in various exemplary embodiments within the scope of the present invention.

Although the above exemplary embodiments are directed to processes executed by a program stored in the storage unit 213, the processes executed by the program may be implemented by hardware.

Further, the processes according to the above exemplary embodiments may be stored as a program on a storage medium, such as an optical disc, and distributed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a first controller configured to store associated information for a plurality of accommodating units accommodating paper, the associated information associating identification information with adjustment information, the identification information identifying each of the accommodating units, the adjustment information being used to adjust at least one of a position of an image formed on the paper, a color of the image, and a tone of the image; and
a second controller configured to form an adjusted image on target paper, the adjusted image being adjusted by using adjustment information stored in association with identification information of at least one of the accommodating units accommodating the target paper.

2. The image forming apparatus according to claim 1,
wherein the first controller is configured to further store attribute information in association with the associated information, the attribute information indicating a property of accommodated paper, and
wherein the first controller is configured to store adjustment information identical to adjustment information associated with the attribute information, in association with another piece of associated information having attribute information that partially matches the attribute information.

3. The image forming apparatus according to claim 1,
wherein the first controller acquires adjusted adjustment information when a predetermined condition is satisfied, and updates stored adjustment information with the acquired adjusted adjustment information, the adjusted adjustment information being adjustment information for which at least one of the position of the image, the color of the image, and the tone of the image has been adjusted.

4. The image forming apparatus according to claim 2,
wherein the first controller acquires adjusted adjustment information when a predetermined condition is satisfied, and updates stored adjustment information with the acquired adjusted adjustment information, the adjusted adjustment information being adjustment information for which at least one of the position of the image, the color of the image, and the tone of the image has been adjusted.

5. The image forming apparatus according to claim 3,
wherein the first controller updates the adjustment information prior to formation of the image on the target paper.

6. The image forming apparatus according to claim 3,
wherein the predetermined condition is at least one of conditions including when a predetermined time elapses after storage of the adjustment information, when an ambient environment of the image forming apparatus changes from a predetermined environment, when maintenance is performed on the image forming apparatus, and when a total number of sheets of the paper on which the image has been formed exceeds a predetermined number.

7. The image forming apparatus according to claim 5,
wherein the predetermined condition is at least one of conditions including when a predetermined time elapses after storage of the adjustment information, when an ambient environment of the image forming apparatus changes from a predetermined environment, when maintenance is performed on the image forming apparatus, and when a total number of sheets of the paper on which the image has been formed exceeds a predetermined number.

8. A non-transitory computer readable medium storing a program causing a computer to execute a process for forming an image, the process comprising:
storing associated information for a plurality of accommodating units accommodating paper, the associated information associating identification information with adjustment information, the identification information identifying each of the accommodating units, the adjustment information being used to adjust at least one of a position of an image formed on the paper, a color of the image, and a tone of the image; and
forming an adjusted image on target paper, the adjusted image being adjusted by using adjustment information stored in association with identification information of at least one of the accommodating units accommodating the target paper.

9. An image forming method comprising:
storing associated information for a plurality of accommodating units accommodating paper, the associated information associating identification information with adjustment information, the identification information identifying each of the accommodating units, the adjustment information being used to adjust at least one of a position of an image formed on the paper, a color of the image, and a tone of the image; and
forming an adjusted image on target paper, the adjusted image being adjusted by using adjustment information stored in association with identification information of at least one of the accommodating units accommodating the target paper.
